(19) United States
(12) Patent Application Publication
(10) Pub. No.: US 2018/0001140 A1
(43) Pub. Date: Jan. 4, 2018

(54) EXERCISE SCHEDULE OPTIMIZER SYSTEM

(71) Applicants: Omri Mendels, Tel Aviv (IL); Merav Greenfeld, Tel Aviv (IL); Avi Samoucha, Tel Aviv (IL); Ronen Aharon Soffer, Tel Aviv (IL); Oded Vainas, Petah Tiqwa (IL)

(72) Inventors: Omri Mendels, Tel Aviv (IL); Merav Greenfeld, Tel Aviv (IL); Avi Samoucha, Tel Aviv (IL); Ronen Aharon Soffer, Tel Aviv (IL); Oded Vainas, Petah Tiqwa (IL)

(21) Appl. No.: 15/199,064

(22) Filed: Jun. 30, 2016

(51) Int. Cl. A63B 24/00; G09B 5/02; G09B 19/00

(52) U.S. Cl. CPC A63B 24/0006; G09B 19/003; G09B 5/02; A63B 2225/50

(57) ABSTRACT

An exercise schedule optimizer system includes a user interface to receive data input from an exerciser and provide data output to the exerciser. The system also includes an exercise goal generator to generate an exercise goal based on at least data regarding the exerciser, an exercise schedule proposer to propose one or more exercise schedule proposals based on at least a historical exercise pattern of the exerciser, and an optimal exercise scheduler to determine an optimal exercise schedule based on at least the one or more exercise schedule proposals.

### TECHNICAL FIELD

Embodiments described herein generally relate to networking, and in particular, to an exercise schedule optimizer system.

### BACKGROUND

Many people set goals for themselves to exercise. These goals could be based on a distance to run or bicycle, a number of steps to walk, a number of times per week to exercise, a number of calories to burn, etc. The goals could also be based on a larger goal, such as a number of pounds to lose before a certain event, such as a family gathering or vacation, or to complete a challenging objective, such as finishing a 10 km race or a marathon. However, people are often hindered from achieving their goals because they cannot find time to exercise.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings, in which:

FIG. 1 is a block diagram illustrating an exercise schedule management system, according to an embodiment;

FIG. 2 is a block diagram illustrating an exercise schedule optimizer system, according to an embodiment;

FIG. 3 is a block diagram illustrating an exercise schedule optimizer, according to an embodiment;

FIG. 4 is a flowchart illustrating a method for optimizing an exercise schedule, according to an embodiment; and

FIG. 5 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Disclosed herein are systems and methods that provide an exercise schedule optimizer system. The exercise schedule optimizer system helps exercisers find the best time slots in their schedules to exercise. Embodiments of the exercise schedule optimizer system consider various factors that include the exerciser's goals, exercise preferences, and constraints.

Conventional training systems do not take into account various factors that impact an exerciser in scheduling a time to exercise. For example, people have different intrinsic preferences for the type to exercise to engage in, the time of day or time within a week to exercise, ideal weather conditions for exercising, etc. that impact when they choose to exercise. Conventional training systems do not take these preferences into account when scheduling exercise.

Embodiments of the exercise schedule optimizer system discussed herein automatically learn exercise patterns of the exerciser over a period of time. For example, the exercise schedule optimizer system may determine that the exerciser usually runs in the evenings after arriving home. In addition, the embodiments may learn constraints of the exerciser regarding exercising. For example, the exerciser may skip exercising if the previous night's sleep was poor, or the exerciser may never go bicycling when it is dark.

Embodiments of the exercise schedule optimizer system also consider a state of the exerciser, for example, the exerciser's health, the exerciser's physical fitness, the exerciser's location, the exerciser's calendar schedule or upcoming holidays, current weather conditions or weather forecast in the area where the exercise is or will be located when planning to exercise, etc.

Embodiments of the exercise schedule optimizer system offer the exerciser proposed time slots to schedule exercise based at least in part on the exercise patterns and state of the exerciser discussed above. In some embodiments, the exercise schedule optimizer may schedule exercise sessions for the exerciser in the exerciser's calendar without direct instructions from the exerciser. The embodiments may also consider the exerciser's goals and/or which exercises the exerciser has already completed out of those schedules or planned in accordance with the exerciser's goals. In addition, the exercise schedule optimizer may establish exercise goals for the exerciser based on the exerciser's stated goals, a state of the exerciser (e.g., level of fitness), and/or the exerciser's historical exercise patterns. These goals may be intermediate goals, in between the exerciser's historical exercise patterns and the exerciser's stated goals. By using the technological advancements discussed herein to propose the best times, for example, within the coming week, for the exerciser to exercise, and/or establishing realistic goals for the exerciser based on the exerciser's state and historical exercise patterns, the exercise schedule optimizer system overcomes problems with prior training systems and assists the exerciser in establishing and achieving the exerciser's goals.

With the emergence of mobile and wearable devices, new functionality has become more readily available. Many devices include sophisticated sensors, processors, radios, and other circuitry that provide notifications, activity and fitness tracking, location tracking, and near real time communications. Such functionality may be leveraged to improve exercise goal setting and scheduling for an exerciser. Through various device activity and fitness trackers (e.g., via sensors, which may include motion sensors, accelerometers, heart rate monitors, etc.) and device location services (e.g., via WiFi, Global Positioning System (GPS), and cell towers), the exerciser's activity schedule and places frequented may be inferred using the exerciser's mobile or wearable device. Using near real time communications between the exerciser's mobile or wearable device and a scheduling application, the exerciser may set exercise goals and schedule exercise either when at a desktop computer or when on the go using information about the exerciser's exercise routine, schedule, and/or other factors such as weather conditions. The scheduling application may be considered a type of artificial fitness coach that assists the exerciser in setting realistic exercise goals and schedules according to the exerciser's own exercise routines, fitness level, schedule, and/or weather conditions, in addition to other factors and information.

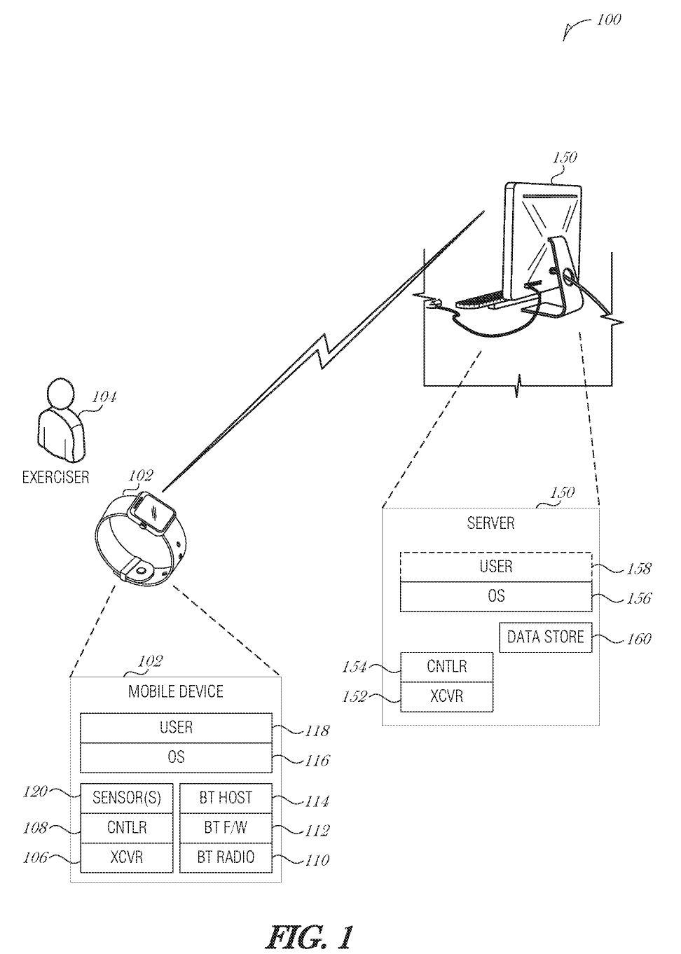

FIG. 1 is a block diagram illustrating an exercise schedule management system 100, according to an embodiment. The exercise schedule management system 100 may include a mobile device 102 and a server 150. The exercise schedule management system 100 may be installed and executed at a local site, such as at an office or medical clinic, or installed and executed from a remote site, such as a data center or a cloud service. Portions of the exercise schedule management system 100 may run locally while other portions may run remotely (with respect to the local elements).

The mobile device 102 may be any type of electronic or computing device, including but not limited to a laptop, smartphone, wearable device, tablet, hybrid device, or the like. The mobile device 102 includes a transceiver 106, capable of both sending and receiving data, and controlled by a controller 108. The transceiver 106 and controller 108 may be used to communicate over various wireless networks, such as a Wi-Fi network (e.g., according to the IEEE 802.11 family of standards); cellular network, such as a network designed according to the Long-Term Evolution (LTE), LTE-Advanced, 5G, or Global System for Mobile Communications (GSM) families of standards; or the like.

The mobile device 102 may include Bluetooth hardware, firmware, and software to enable Bluetooth connectivity according to the IEEE 802.15 family of standards. In an example, the mobile device 102 includes a Bluetooth radio 110 controlled by Bluetooth firmware 112 and a Bluetooth host 114.

An operating system 116 interfaces with the controller 108 and Bluetooth host 114. The operating system 116 may be a desktop operating system, embedded operating system, real-time operating system, proprietary operating system, network operating system, and the like. Examples include, but are not limited to, Windows® NT (and its variants), Windows® Mobile, Windows® Embedded, Mac OS®, Apple iOS, Apple WatchOS®, UNIX, Android™, JavaOS, Symbian OS, Linux, and other suitable operating system platforms.

A communication controller (not shown) may be implemented in hardware, in firmware, or in the operating system 116. The communication controller may act as an interface with various hardware abstraction layer (HAL) interfaces, such as device drivers, communication protocol stacks, libraries, and the like. The communication controller is operable to receive user input (e.g., from a system event or by an express system call to the communication controller), and interact with one or more lower-level communication devices (e.g., Bluetooth radio, Wi-Fi radio, cellular radio, etc.) based on the user input. The communication controller may be implemented, at least in part, in a user-level application that makes calls to one or more libraries, device interfaces, or the like in the operating system 116, to cause communication devices to operate in a certain manner.

A user application space 118 on the mobile device 102 is used to implement user-level applications, controls, user interfaces, and the like, for an exerciser 104 to control the mobile device 102. An application, app, extension, control panel, or other user-level executable software program may be used to control access to the mobile device 102. For example, an executable file, such as an app, may be installed on the mobile device 102 and operable to communicate with a host application installed on the server 150.

The mobile device 102 may include one or more various sensors 120, which may include motion sensors, accelerometers, temperature sensors, humidity sensors, light sensors, heart rate monitors, etc., to sense the exerciser's exercise activities and current health information, and also to sense information about the exerciser's environment using the mobile device 102.

The server 150 may include an operating system, a file system, database connectivity, radios, or other interfaces to provide an exercise monitoring and scheduling system to the mobile device 102. In particular the server 150 may include, or be communicatively connected to, a radio transceiver 152 to communicate with the mobile device 102. A respective controller 154 may control the radio transceiver 152 of the server 150, which in turn is connected with and controlled via an operating system 156 and user-level applications 158.

In operation, the exerciser 104 is able to monitor the exerciser's exercise and activity routine, set realistic exercise goals, and establish an exercise schedule. The details of the exerciser's routine, goals, and schedule are stored at the server 150. The details include types of exercise, duration and/or distance of exercise sessions, exercise heart rate and duration goals, weight goals, physical fitness goals, dates and times of exercise sessions, locations of exercise sessions, sleep patterns, and the like. The server 150 may store the exerciser's routine, goal, and schedule details in a data store 160. The data store 160 may be located at the server 150 or at a remote server (e.g., a database server). The server 150 may provide a reminder to the exerciser 104 about exercise schedule, such as with a notification or other mechanism. The server 150 may also receive location information from the mobile device 102, which may be transmitted on a recurring or periodic basis, on demand, or by other means. The location information may be used by the server 150 to determine the location of the mobile device 102 and inferentially the location of the exerciser 104 of the mobile device 102. Based on the location information, the server 150 may determine details of the exerciser's status. Further details are provided in the following figures and description.

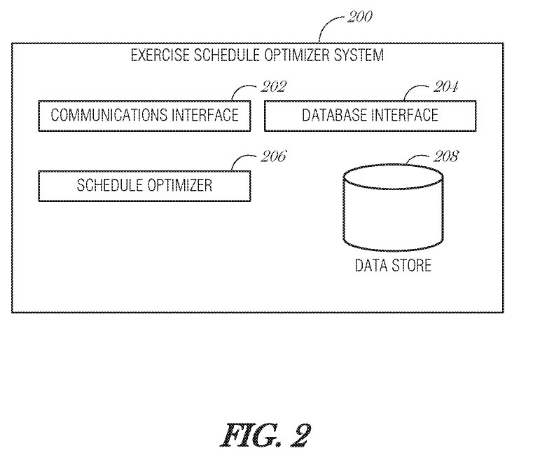

FIG. 2 is a block diagram illustrating an exercise schedule optimizer system 200, according to an embodiment. The exercise schedule optimizer system 200 includes a communications interface 202, a database interface 204, and a schedule optimizer 206. The database interface 204 is used to access a data store 208, which may be co-located with the exercise schedule optimizer system 200 or remote from the exercise schedule optimizer system 200.

The communications interface 202, database interface 204, and schedule optimizer 206 are understood to encompass tangible entities that are physically constructed, specifically configured (e.g., hardwired), or temporarily (e.g., transitorily) configured (e.g., programmed) to operate in a specified manner or to perform part or all of any operations described herein. Such tangible entities may be constructed using one or more circuits, such as with dedicated hardware (e.g., field programmable gate arrays (FPGAs), logic gates, graphics processing units (GPUs), digital signal processors (DSPs), etc.). As such, the tangible entities described herein may be referred to as circuits, circuitry, processor units, subsystems, or the like.

The communications interface 202 may be coupled to one or more radio transmitters, and operable to communicate with a mobile device, e.g., an embodiment of the mobile device 102, the mobile device associated with an exerciser, the location of the mobile device corresponding with a location of the exerciser. The communications interface 202 may be operable to access data from the mobile device, and provide data to the mobile device.

The database interface 204 may be configured to access a database of exercise routines, exercise and/or fitness goals, and exercise schedules for the exerciser, including past or historical exercise events, present exercise events, and prospective or future exercise events. The database interface 204 may also be configured to provide data to the database of exercise routines, exercise goals, and exercise schedules for the exerciser, and also to access data from a location-based database, e.g., a database of places where exercising by the exerciser takes place or a map.

The schedule optimizer 206 may be coupled to the communications interface 202 and the database interface 204, and configured to optimize an exercise schedule using data from the communications interface 202 and/or the database interface 204.

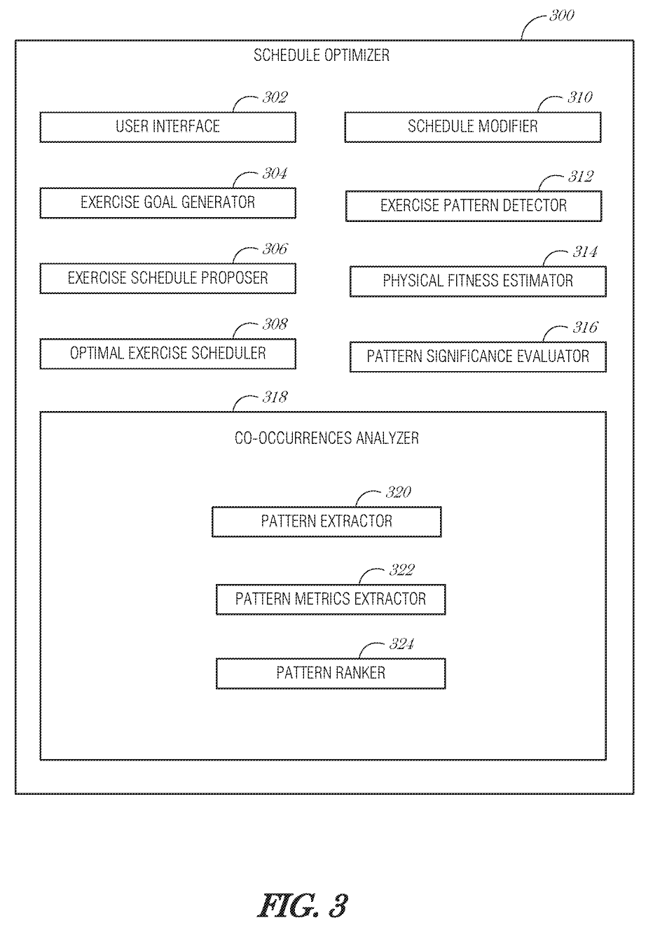

FIG. 3 is a block diagram illustrating a schedule optimizer 300, according to an embodiment. The schedule optimizer 300 may be an embodiment of the schedule optimizer 206. The schedule optimizer 300 may include a user interface 302, an exercise goal generator 304, an exercise schedule proposer 306, an optimal exercise scheduler 308, a schedule modifier 310, an exercise pattern detector 312, a physical fitness estimator 314, a pattern significance evaluator 316, and a co-occurrences analyzer 318. The co-occurrences analyzer 318 may also include a pattern extractor 320, a pattern metrics extractor 322, and a pattern ranker 324.

The user interface 302 may be configured to receive data input from an exerciser 104, and to provide data output to the exerciser 104. The user interface 302 may receive data input from the exerciser 104 via the exerciser 104's mobile device 102, which may be a wearable device. In some embodiments, the user interface 302 may also receive input from the exerciser 104 via a desktop computer or server, e.g., the server 150. The user interface 302 may receive data input from the exerciser 104 via text entry, using graphical gestures, or using voice recognition.

The exercise goal generator 304 may be configured to generate an exercise goal based on at least data regarding the exerciser 104. The data regarding the exerciser may include a historical exercise pattern, physical fitness data, calendar age, metabolic age, weight, height, body fat percentage, body mass index, an exerciser-specified goal, and a prospective schedule of the exerciser 104. The exercise pattern detector 312 may be configured to detect the historical exercise pattern of the exerciser. The exercise goal generator 304 may be further configured to generate the exercise goal also based on weather conditions or a weather forecast. The exercise goal generated by the exercise goal generator 304 may be an intermediate goal based at least in part on the exerciser-specified goal.

The exerciser's historical exercise pattern may be determined using a mobile device, e.g., mobile device 102. The exerciser may wear the mobile device 102 when exercising to collect exercise data for use by the exercise goal generator 304. In this way, the exercise goal generator 304 may observe the exerciser's historical exercise pattern, e.g., a frequency of 3 times per week, a distance of 10 km per week, or burning 2000 calories per week. The exerciser may also wear the mobile device 102 when engaged in other activities that affect the exerciser's state for consideration in scheduling or performing exercise sessions, for example, sleeping. Other items associated with the exerciser's historical exercise pattern include pace, duration of exercise per exercise session, types of exercise (e.g., walking, running, bicycling, spinning, using an elliptical, using a treadmill), etc.

The physical fitness estimator 314 may be configured to estimate the physical fitness data of the exerciser based on at least the historical exercise pattern of the exerciser. The exerciser's physical fitness may be estimated based on the exerciser's data input as well as the exerciser's historical exercise pattern. For example, the data may include the exerciser's weight, height, age, as well as other data pertaining to the physical fitness of a person as known in the art. Additional information about the exerciser's physical fitness may also be obtained during exercise sessions, including resting heart rate and peak heart rate during exercise, as well as how long the peak heart rate is maintained per exercise session.

The exercise schedule proposer 306 may be configured to propose one or more exercise schedule proposals based on at least the historical exercise pattern of the exerciser. The exercise schedule proposer 306 may perform data mining of historical exercise data of the exerciser, including the historical exercise pattern of the exerciser, using the co-occurrences analyzer 318, discussed below. The exercise schedule proposer 306 may include a pattern significance evaluator configured to evaluate a significance of each pattern of the list of commonly occurring historical exercise patterns based on at least the metrics for the pattern. The exercise schedule proposer 306 may extract a list of commonly occurring patterns from the historical exercise data of the exerciser. For example, the exerciser may be determined to have commonly occurring patterns of running on Monday morning after a full night of sleep, not running after a poor night of sleep, running only when the temperature is within a certain range of temperatures or when it is not raining or snowing, etc.

The exercise schedule proposer 306 may be configured to use the co-occurrences analyzer 318 to analyze the historical exercise data of the exerciser to detect the historical exercise pattern of the exerciser. The exercise schedule proposer 306 may use the co-occurrences analyzer 318 to analyze co-occurrences of a plurality of factors including exercise times, exercise locations, weather conditions (e.g., rain, snow, temperature, humidity, air quality, smog levels, pollen levels), daylight time, and/or quality of sleep. The exercise schedule proposer 306 may use the co-occurrences analyzer 318 to analyze the co-occurrences of the plurality of factors over a hierarchy of time semantics including weekday, weekend, day of week, holiday, part of day, hour of day, and time of day.

The co-occurrences analyzer 318 may include the pattern extractor 320, the pattern metrics extractor 322, and the pattern ranker 324. The pattern extractor 320 may be configured to extract a list of commonly occurring historical exercise patterns from the exerciser's historical exercise data. The pattern metrics extractor 322 may be configured to extract metrics for each pattern of the list of commonly occurring historical exercise patterns. The pattern ranker 324 may be configured to assign a rank to each pattern in the list of commonly occurring historical exercise patterns. The rank may be based on the extracted metrics. The exercise schedule proposer 306 may use the pattern significance evaluator 316 to evaluate a significance of each pattern of the list of commonly occurring historical exercise patterns based on at least the metrics for the pattern. In addition, the exercise schedule proposer 306 may rank the one or more exercise schedule proposals based at least in part on the ranked list of commonly occurring historical exercise patterns.

The optimal exercise scheduler 308 may be configured to determine an optimal exercise schedule based on at least the one or more exercise schedule proposals and the data regarding the exerciser. The optimal exercise scheduler 308 may be further configured to determine an optimal exercise schedule based also on a weather forecast. The optimal exercise scheduler 308 may also base the optimal exercise schedule on the list of commonly occurring historical exercise patterns, routines of the exerciser, a current state of the exerciser, and current conditions external to the exerciser (e.g., weather conditions, air quality). The optimal exercise scheduler 308 may evaluate the ranked one or more exercise schedule proposals in conjunction with current conditions (e.g., prospective meetings of the exerciser in the exerciser's schedule database, weather forecast, upcoming holidays, etc.) and determine whether each of the ranked one or more exercise schedule proposals is compatible with the current conditions. The optimal exercise scheduler 308 may determine that the highest ranked exercise schedule proposal that is compatible with the current conditions as the optimal exercise schedule. The optimal exercise schedule may then be presented to the exerciser via the user interface 302.

The schedule modifier 310 may be configured to modify the optimal exercise schedule at a time after determining the optimal exercise schedule based on at least new data acquired after determining the optimal exercise schedule. For example, as the exerciser's state changes and external conditions change (e.g., changes in level of fitness, changes in availability through the exerciser's prospective schedule, the exerciser had a poor night of sleep, the exerciser has skipped a scheduled exercise session, the exerciser was sick, changes in weather conditions, upcoming holidays, etc.), a new optimal exercise schedule may be determined by the schedule modifier 310 by modifying the optimal exercise schedule according to the changes in the exerciser's state and external conditions. The optimal exercise schedule may be changed in order to continue to meet established goals despite the changes.

Embodiments as described with respect to FIG. 3 may assist an exerciser to find optimal times in the exerciser's schedule to exercise, increase the exerciser's motivation to exercise in order to reach goals, and help the exerciser to meet goals. Unlike prior training systems that focus on a current exercise session (e.g., speed, distance, calories burned) or simply aggregate past exercises (e.g., overall number of steps), embodiments as described herein holistically address an exerciser's exercise goals and plans within the context of the exerciser's life, environment, routine behavior, and unique needs, making adjustments to the goals and plan as needed in response to changing circumstances over time.

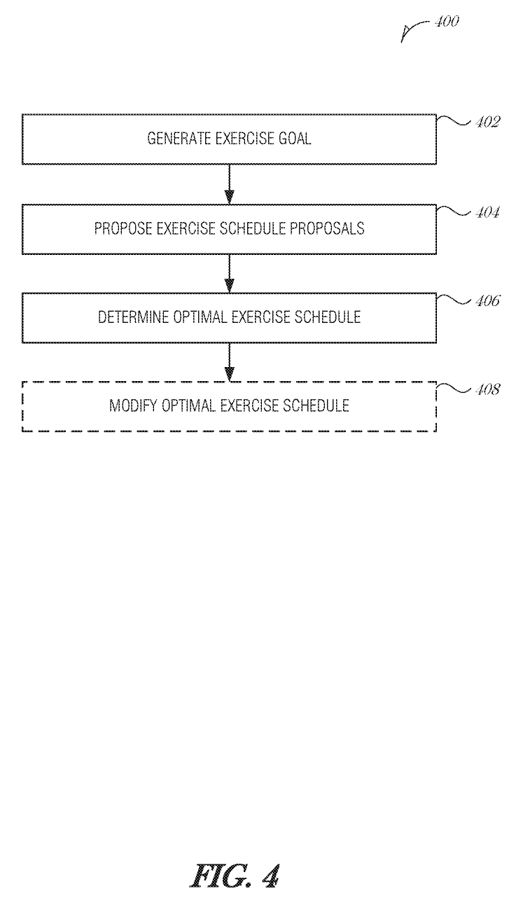

FIG. 4 is a flowchart illustrating a method 400 for optimizing an exercise schedule, according to an embodiment. The method 400 may be performed by embodiments of the schedule optimizer 206 and/or 300.

In an operation 402, an exercise goal is generated. The exercise goal may be based on at least data regarding an exerciser. The data regarding the exerciser may include the historical exercise pattern of the exerciser, physical fitness data of the exerciser, calendar age of the exerciser, metabolic age of the exerciser, weight of the exerciser, height of the exerciser, body fat percentage of the exerciser, body mass index of the exerciser, an exerciser-specified goal, and a prospective schedule of the exerciser. The physical fitness data of the exerciser may be based on at least the historical exercise pattern of the exerciser. The exercise goal may be additionally based on weather conditions or a weather forecast.

For example, if the exerciser specifies a goal to run a specified number of miles a day, this specified goal may be analyzed with respect to the exerciser's physical condition and/or historical exercise pattern, and it may be determined whether it is a realistic goal in view of the exerciser's state and history. If it is determined that it is not consistent, and therefore that the goal is not realistic, then an intermediate goal may be established that is achievable and may help the exerciser make progress toward the exerciser's originally stated goal. As an example, if the exerciser is determined to be in poor physical condition, or has only run 1 mile a week at most up until this point, a goal stated by the exerciser to run 10 miles a day would be considered unrealistic. An intermediate goal may be set automatically, and additional intermediate goals may be established over time to gradually bring the exerciser to achieve the stated goal of 10 miles per day (via operation 408, discussed below).

The historical exercise pattern of the exerciser may be detected, at least in part, by a mobile electronic device, e.g., the mobile device 102. The exerciser may wear the mobile device when exercising to collect exercise data for use in setting exercise goals. In this way, the exerciser's historical exercise pattern may be monitored. The exerciser may also wear the mobile device when engaged in other activities that affect the exerciser's state for consideration in scheduling or performing exercise sessions, for example, sleeping. The data monitored by the mobile device may be recorded as part of the exerciser's historical exercise pattern data.

The generated exercise goal may be an intermediate goal based on a goal specified by the exerciser, the exerciser's state, and/or a historical exercise pattern of the exerciser. In addition, the generated exercise goal may be presented to the exerciser as a proposal if it is determined that the exerciser's stated goal is not realistic based on the exerciser's historical exercise patterns. In this way, an exerciser may receive assistance in setting realistic goals to avoid becoming disillusioned after not being able to achieve unrealistic goals. The exerciser may be assisted to set a series of realistic intermediate goals that may be used to schedule exercise sessions to achieve the exerciser's original stated goal.

When the exercise goal stated by the exerciser is determined to have been achieved regularly in the exerciser's historical exercise patterns, the generated goal may be set to be equal to the exerciser's stated goal, and may be used for purposes of scheduling exercise sessions as discussed below to maintain the exerciser's exercise patterns in accordance with the exerciser's stated goal.

In an operation 404, one or more exercise schedule proposals are proposed. The one or more exercise schedule proposals may be based on at least the historical exercise pattern of the exerciser. The historical exercise pattern of the exerciser may be detected by analyzing co-occurrences of a plurality of factors, including exercise times, exercise locations, weather conditions, daylight time, and quality of sleep. The co-occurrences of the plurality of factors may be conducted over a hierarchy of time semantics including weekday, weekend, day of week, holiday, part of day, hour of day, and time of day. Analyzing the co-occurrences of the plurality of factors may include extracting a list of commonly occurring historical exercise patterns, extracting metrics for each pattern of the list of commonly occurring historical exercise patterns, and ranking for each pattern of the list of commonly occurring historical exercise patterns. A significance of each pattern of the list of commonly occurring historical exercise patterns may also be evaluated based on at least the metrics for the pattern.

The analysis of the co-occurrences essentially generates personalized insights into the exerciser by modeling the exerciser's behavior. Data both regarding the exerciser and external to the exerciser may be collected and stored to facilitate querying of routine behaviors of the exerciser. The data may include the exerciser's past behavior, raw or processed sensory data, and/or external data such as weather conditions or forecast. Data from each sensor, the exerciser's past behavior, external data, and all data to be considered, may each be assigned to a “swim lane” in parallel with each other along a time axis. At a given point in time, states in each “swim lane” may be analyzed to determine co-occurrences. The co-occurrences may be determined from virtual lines crossing the “swim lanes” perpendicular to the time axis at a given time stamp. As discussed below, machine learning processes may be used to determine the significance of each of the co-occurrences. Patterns may be extracted indicating which events are likely to occur with other events based on the determined co-occurrences. For example, a state of the exerciser that the exerciser had a poor night's sleep the prior night would be shown in a “swim lane” parallel with other “swim lanes” corresponding to other states and data all day on the timeline of the “swim lanes” following the night that the exerciser had a poor night's sleep.

Patterns in the data may be detected by clustering co-occurring and consecutive events, mining patterns significant to the exerciser, and ranking data. Pattern mining may be performed based on the events, activities, and states associated with the exerciser's historical exercise patterns, and also based on metadata associated with the historical exercise data, e.g., exercise duration, distance, calories burned, etc. For example, a pattern that the exerciser usually exercises twice per week may be determined by pattern mining, and then the exercise may be scheduled to exercise twice per week automatically without the exerciser being queried how many times per week the exercise would like to exercise.

To cluster co-occurrences, all co-occurrences between two or more events or factors may be calculated. One of these two or more events or factors may be a user action, and the others may be states of the exerciser. Examples of such co-occurrences include:
Running<->Morning
Running<->Morning<->Central Park
Swimming<->Weekend<->Night
Swimming<->Saturday<->Night
Biking<->Daylight<->Weekday

To cluster consecutive events, events occurring prior to a planned exercise period may be considered and clustered with the exercise period. Events occurring prior to the planned exercise period may be considered part of the exerciser's state. These events including sleep quality, meetings or scheduled events and activities that might affect the exerciser's activity routines. The clustering of consecutive events may also be combined with clustering of co-occurrences. Examples of clustered consecutive events include:
Full Night Sleep->Running
{Exercise<->Night}->{Canceled Exercise<->Morning}
Meeting->Canceled Exercise

Mining for patterns significant to the exerciser includes aggregating and evaluating each pattern identified in the data both regarding the exerciser and external to the exerciser. The frequency of the patterns is also evaluated as part of determining its significance. Sporadic patterns that have low frequency, and therefore low support in the data, may be removed from the list of commonly occurring historical exercise patterns. For example:
Running<->Morning (17 times)
Running<->Morning<->Central Park (12 times)
Swimming<->Weekend<->Night (1 time)
Biking<->Daylight<->Weekday (9 times)

Each pattern in the list of commonly occurring patterns may be ranked by utilizing one or more different metrics. These metrics include confidence, significance, durational support, and significance given data decay. Other metrics may also be defined.

When ranking according to the confidence metric, the number of times that the activity of the pattern occurred in the state of the pattern vs. other states across all patterns identified in the data both regarding the exerciser and external to the exerciser is evaluated. This may be represented according to the following formula:

Confidence=P(A∩S)/P(A) Eq. 1

where P is the number of times the pattern occurred in the data. A is the activity, and S is the state. The state may be any of the types of states discussed herein and the like, for example, the time (e.g., morning, weekend, holiday, etc.), the place (at home, near home, at work, near work, at the gym, etc.), and correlated with another event (e.g., after a good night's sleep).

When ranking according to significance, a density of each state in the patterns of the list of commonly occurring patterns is estimated in order to assign a preference to fine-grained states, or those states that have more specificity than other states of a similar type (e.g., for a time type state, morning is more fine-grained than weekday, and therefore more specific and less dense). This may be represented according to the following formula:

Density=Σ_{sεS}durationₛ/overall time period Eq. 2

For example, the density of “weekday” would be 5/7, because there are 5 weekdays out of the 7 days of a week. Likewise, “Monday morning” would have a density of 4/168, since Monday morning is 4 hours long out of a total of 168 hours in a week. Significance may then be determined according to both the density and the confidence by multiplying confidence by (unity minus density), as represented according to the following formula:

Significance=Confidenceₛ·(1−Densityₛ) Eq. 3

When ranking according to durational support, the number of times that each event in the patterns of the list of commonly occurring patterns occurs over a given time period is evaluated. For example, the given time period may be considered to be daily, weekly, biweekly, monthly, bi monthly, quarterly, semiannually, annually, biannually, etc. Ranking according to durational support helps find frequent patterns that are not routine (e.g., out of the exerciser's general routine), or used to be routine but are no longer routine (e.g., belong to an expired routine).

When ranking according to significance given data decay, the weight given to events that are closer in time is greater than events which are further in time from the present or reference time for the ranking process. By giving greater weight to events that are closer in time, changes in the behavior of the exerciser are better supported. Frequently or regularly repeating a new activity over a period of time helps to make the new activity become a habit. When the new activity is not frequently or regularly repeated, it is less likely to become a habit.

For purposes of ranking, there may be predefined thresholds given to the different metrics. When the metrics for a pattern do not rise above the predefined thresholds, the pattern may be dropped from the list of commonly occurring patterns. The remaining patterns may then be ranked according to the metrics based upon which the patterns are evaluated, and a ranked list of probable patterns for consideration as candidates for the optimal exercise schedule may be output. For example:
Running<->Monday<->Morning<->Park {significance=0.87}
Running<->Wednesday<->Evening<->Gym {significance=0.65}
Swimming<->Monday<->Morning<->Rain {significance=0.6}

Given the information output by the analysis of the co-occurrences, behavioral insights about the exerciser's historical exercise patterns may be extracted and used to determine an optimal exercise schedule. For example, the analysis of co-occurrences may be used to determine that on rainy days, the exerciser goes swimming instead of running. This extraction of behavioral insights may be performed by a co-occurrences analyzer using an inference engine, machine learning system, artificial intelligence system, or the like in various embodiments.

In an operation 406, an optimal exercise schedule is determined based on at least the one or more exercise schedule proposals. The optimal exercise schedule may be additionally determined based on the data regarding the exerciser, weather conditions, and/or a weather forecast. Based on behavioral insights inferred from the exerciser's historical exercise patterns, the exerciser may only be scheduled for exercise sessions according to conditions in which the exercise has historical exercised, and the exercise will not be bothered with unnecessary questions or proposed exercise sessions that are inconsistent with the exerciser's historical exercise patterns. This makes scheduling of exercises much easier for the exerciser than prior training systems.

In an optional operation 408, the optimal exercise schedule is modified at a time after determining the optimal exercise schedule based on at least new data acquired after determining the optimal exercise schedule. This new data may include events that have occurred since the optimal exercise schedule was determined. The co-occurrences analyses discussed above may be conducted in optional operation 408.

As an example, the exerciser may be prompted to make a change to the exerciser's exercise schedule according to various changes in conditions since the optimal exercise schedule was determined or out of the normal routine on which the optimal exercise schedule was based. Examples of such prompts include:
“Although you are running every Monday at 6 pm, this week you should consider running on Monday morning because you have a late meeting at work that day.”
“This is a holiday weekend, so you should run on Thursday morning instead of Sunday since you start late on that day.”
“Looks like it is going to rain tomorrow, so it would be better to run at the gym than outside after you get home. You can consider going to the gym after work. Don't forget to take your gym bag in the morning.”

As another example, the organizer may skip an exercise session that was scheduled according to the optimal exercise schedule. The new data acquired may include that the exerciser had a poor night's sleep prior to the scheduled exercise session. More detailed data regarding sleep in the night prior to a scheduled exercise session may be obtained through monitoring by a wearable device or input from the exerciser, and evaluated using the analysis of co-occurrences discussed above when rescheduling a skipped exercise session. In addition, metadata regarding each exercise session may also be obtained through monitoring by a wearable device or input from the exerciser, and evaluated using the analysis of co-occurrences discussed above when rescheduling a skipped exercise session. As an example, the following co-occurrences may be determined and evaluated:
7 km/h<->Monday<->Morning<->Park<-6 sleep hours
11 km/h<->Monday<->Morning<->Park<-8 sleep hours
   Thus, it may be inferred that the exerciser still runs on Monday morning in the park when the exerciser gets 6 hours sleep the prior night, but runs slower than when the exerciser gets 8 hours sleep the prior night. This information may be used to determine when to reschedule a skipped exercise session, or to find an optimal time for an exercise based on the exerciser's state.

As another example, an exerciser may have set a goal to jog four times per week, but the exerciser's historical exercise patterns show that the exerciser only jogs once per week. The both the exerciser's goal and exercise schedule may be revised to help the exerciser achieve the original goal of four times per week. An intermediate goal of twice per week may be established, and exercise sessions may be scheduled in accordance with this intermediate goal. As the exerciser begins to meet the intermediate goal, another intermediate goal may be established according to the exerciser's progress toward the exerciser's original goal. Exercise sessions may then be established going forward according to this new intermediate goal. Thus, both the goals and the exercise schedules may be dynamically determined according to the exerciser's adherence to prior set goals and exercise schedules and progress toward the exerciser's originally stated goals.

Example 1 is an exercise schedule optimizer system, the system comprising: a user interface to: receive data input from an exerciser; and provide data output to the exerciser; an exercise goal generator to generate an exercise goal based on at least data regarding the exerciser; an exercise schedule proposer to propose one or more exercise schedule proposals based on at least a historical exercise pattern of the exerciser; and an optimal exercise scheduler to determine an optimal exercise schedule based on at least the one or more exercise schedule proposals.

In Example 2, the subject matter of Example 1 optionally includes a schedule modifier to modify the optimal exercise schedule at a time after determining the optimal exercise schedule based on at least new data acquired after determining the optimal exercise schedule.

In Example 3, the subject matter of any one or more of Examples 1-2 optionally includes wherein the optimal exercise schedule is additionally determined based on the data regarding the exerciser, the data regarding the exerciser including at least one data type selected from the group consisting of the historical exercise pattern of the exerciser, physical fitness data of the exerciser, calendar age of the exerciser, metabolic age of the exerciser, weight of the exerciser, height of the exerciser, body fat percentage of the exerciser, body mass index of the exerciser, an exerciser-specified goal, and a prospective schedule of the exerciser.

In Example 4, the subject matter of Example 3 optionally includes an exercise pattern detector to detect, at least in part, the historical exercise pattern of the exerciser.

In Example 5, the subject matter of any one or more of Examples 3-4 optionally includes a physical fitness estimator to estimate the physical fitness data of the exerciser based on at least the historical exercise pattern of the exerciser.

In Example 6, the subject matter of any one or more of Examples 1-5 optionally includes wherein the exercise goal generator generates the exercise goal also based on weather conditions.

In Example 7, the subject matter of any one or more of Examples 1-6 optionally includes a co-occurrences analyzer to analyze co-occurrences of a plurality of factors, wherein the exercise schedule proposer uses the co-occurrences analyzer to detect the historical exercise pattern of the exerciser by analyzing co-occurrences of a plurality of factors selected from the list of factors consisting of exercise times, exercise locations, weather conditions, daylight time, and quality of sleep.

In Example 8, the subject matter of Example 7 optionally includes wherein the exercise schedule proposer uses the co-occurrences analyzer to analyze the co-occurrences of the plurality of factors over a hierarchy of time semantics including weekday, weekend, day of week, holiday, part of day, hour of day, and time of day.

In Example 9, the subject matter of any one or more of Examples 7-8 optionally includes wherein the analyzing the co-occurrences of the plurality of factors comprises extracting a list of commonly occurring historical exercise patterns, extracting metrics for each pattern of the list of commonly occurring historical exercise patterns, and ranking for each pattern of the list of commonly occurring historical exercise patterns.

In Example 10, the subject matter of Example 9 optionally includes wherein the exercise schedule proposer is further configured to evaluate a significance of each pattern of the list of commonly occurring historical exercise patterns based on at least the metrics for the pattern.

In Example 11, the subject matter of any one or more of Examples 1-10 optionally includes wherein the optimal exercise scheduler is further configured to determine the optimal exercise schedule based also on a weather forecast.

Example 12 is a method of optimizing an exercise schedule, the method comprising: generating an exercise goal based on at least data regarding an exerciser; proposing one or more exercise schedule proposals based on at least a historical exercise pattern of the exerciser; and determining an optimal exercise schedule based on at least the one or more exercise schedule proposals.

In Example 13, the subject matter of Example 12 optionally includes modifying the optimal exercise schedule at a time after determining the optimal exercise schedule based on at least new data acquired after determining the optimal exercise schedule.

In Example 14, the subject matter of any one or more of Examples 12-13 optionally includes wherein the optimal exercise schedule is additionally determined based on the data regarding the exerciser, the data regarding the exerciser including at least one data type selected from the group consisting of the historical exercise pattern of the exerciser, physical fitness data of the exerciser, calendar age of the exerciser, metabolic age of the exerciser, weight of the exerciser, height of the exerciser, body fat percentage of the exerciser, body mass index of the exerciser, an exerciser-specified goal, and a prospective schedule of the exerciser.

In Example 15, the subject matter of Example 14 optionally includes detecting the historical exercise pattern of the exerciser, at least in part, by a mobile electronic device.

In Example 16, the subject matter of any one or more of Examples 14-15 optionally includes estimating the physical fitness data of the exerciser based on at least the historical exercise pattern of the exerciser.

In Example 17, the subject matter of any one or more of Examples 12-16 optionally includes wherein generating the exercise goal is also based on weather conditions.

In Example 18, the subject matter of any one or more of Examples 12-17 optionally includes wherein proposing the one or more exercise schedule proposals comprises detecting the historical exercise pattern of the exerciser by analyzing co-occurrences of a plurality of factors selected from the list of factors consisting of exercise times, exercise locations, weather conditions, daylight time, and quality of sleep.

In Example 19, the subject matter of Example 18 optionally includes wherein the analyzing the co-occurrences of the plurality of factors is conducted over a hierarchy of time semantics including weekday, weekend, day of week, holiday, part of day, hour of day, and time of day.

In Example 20, the subject matter of any one or more of Examples 18-19 optionally includes wherein the analyzing the co-occurrences of the plurality of factors comprising extracting a list of commonly occurring historical exercise patterns, extracting metrics for each pattern of the list of commonly occurring historical exercise patterns, and ranking for each pattern of the list of commonly occurring historical exercise patterns.

In Example 21, the subject matter of Example 20 optionally includes evaluating a significance of each pattern of the list of commonly occurring historical exercise patterns based on at least the metrics for the pattern.

In Example 22, the subject matter of any one or more of Examples 12-21 optionally includes wherein determining an optimal exercise schedule is also based on a weather forecast.

Example 23 is at least one machine-readable medium including instructions, which when executed by a machine, cause the machine to perform operations of any of the methods of Examples 12-22.

Example 24 is an apparatus comprising means for performing any of the methods of Examples 12-22.

Example 25 is an exercise schedule optimizer system, the system comprising: means for generating an exercise goal based on at least data regarding an exerciser; means for proposing one or more exercise schedule proposals based on at least a historical exercise pattern of the exerciser; and means for determining an optimal exercise schedule based on at least the one or more exercise schedule proposals.

In Example 26, the subject matter of Example 25 optionally includes means for modifying the optimal exercise schedule at a time after determining the optimal exercise schedule based on at least new data acquired after determining the optimal exercise schedule.

In Example 27, the subject matter of any one or more of Examples 25-26 optionally includes wherein the optimal exercise schedule is additionally determined based on the data regarding the exerciser, the data regarding the exerciser including at least one data type selected from the group consisting of the historical exercise pattern of the exerciser, physical fitness data of the exerciser, calendar age of the exerciser, metabolic age of the exerciser, weight of the exerciser, height of the exerciser, body fat percentage of the exerciser, body mass index of the exerciser, an exerciser-specified goal, and a prospective schedule of the exerciser.

In Example 28, the subject matter of Example 27 optionally includes means for detecting the historical exercise pattern of the exerciser, at least in part, by a mobile electronic device.

In Example 29, the subject matter of any one or more of Examples 27-28 optionally includes means for estimating the physical fitness data of the exerciser based on at least the historical exercise pattern of the exerciser.

In Example 30, the subject matter of any one or more of Examples 25-29 optionally includes wherein generating the exercise goal is also based on weather conditions.

In Example 31, the subject matter of any one or more of Examples 25-30 optionally includes means for analyzing co-occurrences and means for detecting the historical exercise pattern of the exerciser, the means for detecting the historical exercise pattern of the exerciser using the means for analyzing co-occurrences to analyze co-occurrences of a plurality of factors selected from the list of factors consisting of exercise times, exercise locations, weather conditions, daylight time, and quality of sleep.

In Example 32, the subject matter of Example 31 optionally includes wherein the means for detecting the historical exercise pattern of the exerciser analyzes the co-occurrences of the plurality of factors over a hierarchy of time semantics including weekday, weekend, day of week, holiday, part of day, hour of day, and time of day.

In Example 33, the subject matter of any one or more of Examples 31-32 optionally includes wherein the means for analyzing co-occurrences comprises means for extracting a list of commonly occurring patterns, means for extracting metrics for each pattern of the list of commonly occurring patterns, and means for ranking each pattern of the list of commonly occurring patterns, and the means for detecting the historical exercise pattern of the exercises uses the means for analyzing co-occurrences to extract a list of commonly occurring historical exercise patterns, extract metrics for each pattern of the list of commonly occurring historical exercise patterns, and rank each pattern of the list of commonly occurring historical exercise patterns.

In Example 34, the subject matter of Example 33 optionally includes means for evaluating a significance of each pattern, and the means for detecting the historical exercise pattern of the exercises uses the means for evaluating the significance of each pattern to evaluate the significance of each pattern of the list of commonly occurring historical exercise patterns based on at least the metrics for the pattern.

In Example 35, the subject matter of any one or more of Examples 25-34 optionally includes wherein determining an optimal exercise schedule is also based on a weather forecast.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instructions on the machine-readable medium. The processor subsystem may include one or more processors, each with one or more cores. Additionally, the processor subsystem may be disposed on one or more physical devices. The processor subsystem may include one or more specialized processors, such as a GPU, a DSP, an FPGA, or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term “hardware module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computer, laptop computer, tablet computer, server, smart phone, etc.

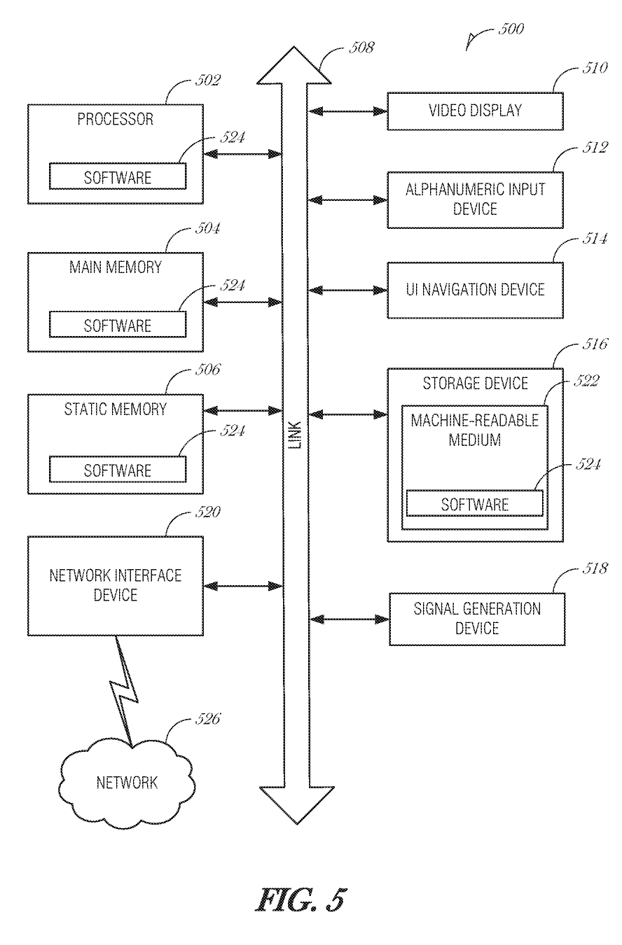

FIG. 5 is a block diagram illustrating a machine in the example form of a computer system 500, within which a set or sequence of instructions may be executed to cause the machine to perform any one or more of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a wearable device, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

The computer system 500 includes at least one processor 502 (e.g., a central processing unit (CPU), a GPU, or both, processor cores, compute nodes, etc.), a main memory 504, and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512, and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a GPS sensor, compass, accelerometer, gyrometer, magnetometer, or other sensor.

The storage device 516 includes a machine-readable medium 522 on which is stored one or more sets of data structures and software 524 (e.g., instructions) embodying or utilized by any one or more of the methodologies or functions described herein. The instructions 524 may also reside, completely or at least partially, within the main memory 504, within the static memory 506, and/or within the processor 502 during execution thereof by the computer system 500, with the main memory 504, the static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communication network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. An exercise schedule optimizer system, the system comprising:
a user interface to:
receive data input from an exerciser; and
provide data output to the exerciser;
an exercise goal generator to generate an exercise goal based on at least data regarding the exerciser;
an exercise schedule proposer to propose one or more exercise schedule proposals based on at least a historical exercise pattern of the exerciser; and
an optimal exercise scheduler to determine an optimal exercise schedule based on at least the one or more exercise schedule proposals.

2. The system of claim 1, further comprising a schedule modifier to modify the optimal exercise schedule at a time after determining the optimal exercise schedule based on at least new data acquired after determining the optimal exercise schedule.

3. The system of claim 1, wherein the optimal exercise schedule is additionally determined based on the data regarding the exerciser, the data regarding the exerciser including at least one data type selected from the group consisting of the historical exercise pattern of the exerciser, physical fitness data of the exerciser, calendar age of the exerciser, metabolic age of the exerciser, weight of the exerciser, height of the exerciser, body fat percentage of the exerciser, body mass index of the exerciser, an exerciser-specified goal, and a prospective schedule of the exerciser.

4. The system of claim 3, further comprising an exercise pattern detector to detect, at least in part, the historical exercise pattern of the exerciser.

5. The system of claim 3, further comprising a physical fitness estimator to estimate the physical fitness data of the exerciser based on at least the historical exercise pattern of the exerciser.

6. The system of claim 1, wherein the exercise goal generator generates the exercise goal also based on weather conditions.

7. The system of claim 1, further comprising a co-occurrences analyzer to analyze co-occurrences of a plurality of factors, wherein the exercise schedule proposer uses the co-occurrences analyzer to detect the historical exercise pattern of the exerciser by analyzing co-occurrences of a plurality of factors selected from the list of factors consisting of exercise times, exercise locations, weather conditions, daylight time, and quality of sleep.

8. The system of claim 7, wherein the exercise schedule proposer uses the co-occurrences analyzer to analyze the co-occurrences of the plurality of factors over a hierarchy of time semantics including weekday, weekend, day of week, holiday, part of day, hour of day, and time of day.

9. The system of claim 7, wherein the analyzing the co-occurrences of the plurality of factors comprises extracting a list of commonly occurring historical exercise patterns, extracting metrics for each pattern of the list of commonly occurring historical exercise patterns, and ranking for each pattern of the list of commonly occurring historical exercise patterns.

10. The system of claim 9, wherein the exercise schedule proposer is further configured to evaluate a significance of each pattern of the list of commonly occurring historical exercise patterns based on at least the metrics for the pattern.

11. The system of claim 1, wherein the optimal exercise scheduler is further configured to determine the optimal exercise schedule based also on a weather forecast.

12. A method of optimizing an exercise schedule, the method comprising:
generating an exercise goal based on at least data regarding an exerciser;
proposing one or more exercise schedule proposals based on at least a historical exercise pattern of the exerciser; and
determining an optimal exercise schedule based on at least the one or more exercise schedule proposals.

13. The method of claim 12, wherein the optimal exercise schedule is additionally determined based on the data regarding the exerciser, the data regarding the exerciser including at least one data type selected from the group consisting of the historical exercise pattern of the exerciser, physical fitness data of the exerciser, calendar age of the exerciser, metabolic age of the exerciser, weight of the exerciser, height of the exerciser, body fat percentage of the exerciser, body mass index of the exerciser, an exerciser-specified goal, and a prospective schedule of the exerciser.

14. The method of claim 13, further comprising detecting the historical exercise pattern of the exerciser, at least in part, by a mobile electronic device.

15. The method of claim 13, further comprising estimating the physical fitness data of the exerciser based on at least the historical exercise pattern of the exerciser.

16. The method of claim 12, wherein proposing the one or more exercise schedule proposals comprises detecting the historical exercise pattern of the exerciser by analyzing co-occurrences of a plurality of factors selected from the list of factors consisting of exercise times, exercise locations, weather conditions, daylight time, and quality of sleep.

17. The method of claim 16, wherein the analyzing the co-occurrences of the plurality of factors is conducted over a hierarchy of time semantics including weekday, weekend, day of week, holiday, part of day, hour of day, and time of day.

18. The method of claim 16, wherein the analyzing the co-occurrences of the plurality of factors comprising extracting a list of commonly occurring historical exercise patterns, extracting metrics for each pattern of the list of commonly occurring historical exercise patterns, and ranking for each pattern of the list of commonly occurring historical exercise patterns.

19. The method of claim 18, further comprising evaluating a significance of each pattern of the list of commonly occurring historical exercise patterns based on at least the metrics for the pattern.

20. At least one machine-readable medium including instructions, which when executed by a machine, cause the machine to perform operations comprising:
generating an exercise goal based on at least data regarding an exerciser;
proposing one or more exercise schedule proposals based on at least a historical exercise pattern of the exerciser; and
determining an optimal exercise schedule based on at least the one or more exercise schedule proposals.

21. The machine-readable medium of claim 20, the operations further comprising modifying the optimal exercise schedule at a time after determining the optimal exercise schedule based on at least new data acquired after determining the optimal exercise schedule.

22. The machine-readable medium of claim 20, wherein the optimal exercise schedule is additionally determined based on the data regarding the exerciser, the data regarding the exerciser including at least one data type selected from the group consisting of the historical exercise pattern of the exerciser, physical fitness data of the exerciser, calendar age of the exerciser, metabolic age of the exerciser, weight of the exerciser, height of the exerciser, body fat percentage of the exerciser, body mass index of the exerciser, an exerciser-specified goal, and a prospective schedule of the exerciser.

23. The machine-readable medium of claim 22, the operations further comprising detecting the historical exercise pattern of the exerciser, at least in part, by a mobile electronic device.

24. The machine-readable medium of claim 20, wherein generating the exercise goal is also based on weather conditions.

25. The machine-readable medium of claim 20, wherein determining an optimal exercise schedule is also based on a weather forecast.
